(19) United States
(12) Patent Application Publication
(10) Pub. No.: US 2020/0311793 A1
(43) Pub. Date: Oct. 1, 2020

(54) Method of Evaluating Body Language Using Video Analytics, Virtual Store Areas, and Machine Learning

(71) Applicant: Toshiba Global Commerce Solutions Holdings Corporation, Tokyo (JP)

(72) Inventors: Susan W. Brosnan, Raleigh, NC (US); James Hawk, Morrisville, NC (US)

(21) Appl. No.: 16/364,901

(22) Filed: Mar. 26, 2019

(51) Int. Cl. G06Q 30/06; G06N 5/02; G06Q 30/02; G06K 9/00

(52) U.S. Cl. CPC G06Q 30/0613; G06N 5/02; G06K 9/00335; G06K 9/00302; G06K 9/00228; G06Q 30/0202

(57) ABSTRACT

A behavioral model defining a current behavior of a consumer in a retail store is generated by a computer based on digital images of the consumer captured in the retail store. The computer then analyzes the generated behavioral model relative to one or more baseline behavioral models, which consider the consumer's specific location within the store, and, based on the results of that analysis, predicts whether the consumer requires assistance. Additionally, the computer implements a learning process that allows it to determine whether the prediction was incorrect, and if so, to update the associated baseline behavioral models.

### TECHNICAL FIELD

The present disclosure relates generally to the operation of retail stores and, more particularly to devices and techniques for predicting whether a consumer requires assistance based on the consumer's behavior.

### BACKGROUND

Traditional “brick-and-mortar” establishments currently face a long list of competitive challenges. Among these are the ever-increasing costs due to overhead, merchandise, managing inventory, and the rapid pace at which technology changes. For example, an increasing number of shoppers are taking advantage of on-line shopping from vendors such as AMAZON. Although on-line shoppers cannot walk through a “showroom” to examine a physical product, as they can in a brick-and-mortar establishment, on-line shopping is convenient. Further, on-line vendors are able to offer the same or similar products at prices that, in some cases, are deeply discounted. Additionally, in many cases, on-line purchases are not subject to sales tax.

These challenges notwithstanding, brick-and-mortar establishments have an advantage over on-line vendors in that their employees are able to engage their consumers personally when they are in the store. Such personal engagement can be especially beneficial when consumers feel that a store employee can quickly and efficiently assist them in finding a particular piece of merchandise.

### BRIEF DESCRIPTION OF THE DRAWINGS

FIG. 1 is a schematic block diagram illustrating a communications network for predicting whether a consumer in a brick-and-mortar establishment requires assistance based on the behavior of the consumer according to one embodiment of the present disclosure.

FIG. 2 is a schematic block diagram illustrating a brick-and-mortar retail establishment partitioned into a plurality of virtual sections according to one embodiment of the present disclosure.

FIG. 3 is a flow diagram illustrating a method for predicting whether a consumer requires assistance based on the behavior of the consumer according to one embodiment of the present disclosure.

FIG. 4 is a flow diagram illustrating a method for dynamically updating behavioral models that associate a consumer's behavior with whether the consumer needs assistance according to one embodiment of the present disclosure.

FIG. 5 is a schematic block diagram illustrating the main functional components of a computing device configured to predict whether a consumer requires assistance based on the behavior of the consumer according to one embodiment of the present disclosure.

FIG. 6 is a schematic block diagram of a computer program product configured to predict whether a consumer requires assistance based on the behavior of the consumer according to one embodiment of the present disclosure.

### DETAILED DESCRIPTION

Customer service is becoming increasingly more important in attracting consumers to shop in a brick-and-mortar establishment. However, it can be difficult for store associates to accurately determine whether a consumer actually needs assistance. Thus, store associates can be slow to offer assistance to consumers who really need the help, or conversely, interfere with a consumer that does not actually need assistance.

Further, wages for associates are increasing, and while brick-and-mortar establishments generally have a limited number of store associates, those numbers are decreasing due, in part, to the wage increases. Therefore, it is important for brick-and-mortar establishments to utilize their associates in ways that are most likely to help consumers in actual need of assistance. That is, it is important for brick-and-mortar establishments to deploy their store associates in an effective manner in order to provide customers with the “personalized experience” that gives the brick-and-mortar establishments an advantage over their on-line competitors.

Therefore, embodiments of the present disclosure provide a method, device, and corresponding computer program product for analyzing the behavior of an in-store consumer, and using that analysis to predict whether that consumer does or does not require assistance. Particularly, embodiments of the present disclosure generate a behavioral model defining the current behavior (i.e., a current body language profile) of a consumer at a particular location in a retail store, and analyze that behavioral model relative to one or more baseline behavioral models that define a baseline consumer behavior (i.e., baseline body language profiles) for that location in the store. Based on the results of that analysis, the present embodiments predict whether the consumer at that location does nor does not actually require assistance. Additionally, embodiments of the present disclosure provide a machine-based learning method to determine whether a given analysis was correct, and to update the baseline behavioral models on which the analysis and prediction is based accordingly.

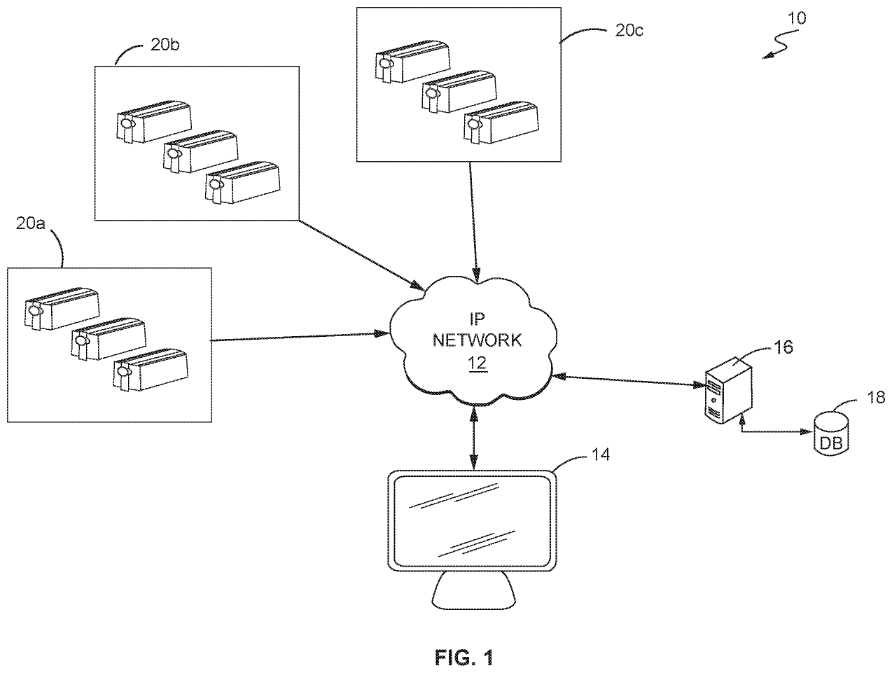

Referring now to the drawings, FIG. 1 is a schematic block diagram illustrating a communications system 10 for predicting whether a consumer in a brick-and-mortar establishment requires assistance based on the behavior of the consumer. As seen in FIG. 1, system 10 comprises a network 12, which can be any private and/or public IP-based network, communicatively connecting a computer 14, a computer server 16, a database 18, and a plurality of cameras 20a, 20b, 20c (collectively, “cameras 20”).

Computer 14 can be any computer known in the art, such as a desktop, laptop, notebook, tablet, mobile telephone, or other such mobile device, for example, and is configured to provide a retailer with an interface to the computer server 16 and the cameras 20. For example, using computer 14, the retailer is able to define and provision computer server 16 with one or more baseline behavioral models for storage in database 18, control the cameras 20 either individually or in groups, and generally control the overall functioning of the system 10.

Computer server 16 may also comprise any computer device known in the art and is configured according to the present embodiments to receive one or more baseline behavioral models for processing and storage in the database 18. As previously stated, the baseline behavioral models may be provisioned by computer 14, with each baseline behavioral model defining a unique baseline body language profile for consumers at a corresponding location in the retail store. The baseline behavioral models can comprise any data needed or desired. However, in one embodiment, each baseline behavioral model comprises biometric information representing the facial features of a hypothetical consumer showing a particular baseline facial expression, as well as data representing a baseline gesture or set of baseline gestures that a hypothetical consumer could make. By way of example only, facial expressions include, but are not limited to, those made by a person when smiling, frowning, confused, lost, and the like. Similarly, gestures comprise those made by a person when while shopping. These types of gestures include putting one or both hands on their hips or some other part of their body, throwing one or both hands in the air, turning around repeatedly, rapid arm movement, eyes widening or narrowing, running, standing in the same place for an extended period of time, and the like.

In addition to the obtaining baseline behavioral models, computer server 16 is also configured to generate behavioral models defining a current body language profile of the consumer at a particular location in the store. To accomplish this function, computer server 16 analyzes one or more digital images of the consumer captured by cameras 20 positioned at or near the current location of the consumer, and generates a file comprising the resultant data of the behavioral model. As above, such data includes, but is not limited to, biometric information representing the current facial features of the consumer, as well as data representing a gesture or set of gestures currently being made by the consumer. The computer server 16 then analyzes the generated behavioral models against the baseline behavioral models, and predicts whether a consumer needs assistance based on that analysis. If it is determined that a consumer requires assistance, computer server 16 sends an alert message to an operator associated with the store (e.g., a sales associate) indicating that they should go to the consumer to render assistance. Computer server 16 is also configured to learn whether a given analysis was correct or incorrect, and to update the baseline behavioral models on which the analysis and prediction is based accordingly.

Those of ordinary skill in the art will appreciate that there are third-party algorithms and systems readily available for generating the data representing the various facial features and/or gestures of a person with data in an output file. However, the particular algorithm and/or system that is used to perform these functions is not germane to the embodiments of the present disclosure, and thus, none are explained in detail here.

Embodiments of the present disclosure recognize that the meanings of the facial expressions and gestures exhibited by a consumer will typically vary depending upon the location of the consumer within a store. Further, these same gestures and expressions in one location may indicate that the consumer needs assistance while in another location, they do not. For example, a consumer who has a “puzzled” look on their face and is repeatedly turning around in a first part of a store (e.g., a produce section) may be lost, confused, or simply looking for a product they cannot find. In these cases, such consumers would likely need assistance from a store associate. However, this same or similar gesture and facial expression exhibited by the consumer in another section of the store (e.g., a clothing section) may indicate that the consumer is simply trying on or testing merchandise in order to determine whether they really want to purchase the merchandise. In these latter cases, the consumer may not require assistance from a store associate. Accordingly, the present disclosure configures the computer server 16 to utilize the location of the consumer when making a determination of whether that consumer does or does not require assistance.

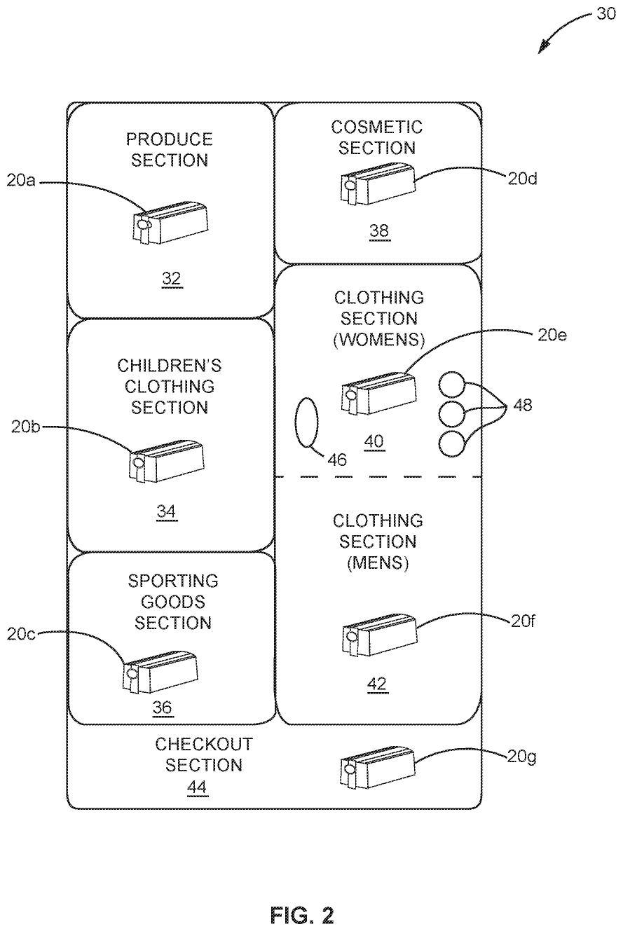

More particularly, as seen in FIG. 2, embodiments of the present disclosure partition the brick-and-mortar retail store 30 into a plurality of virtual sections 32-44. The partitioning may follow any desired logic or reasoning, but in this embodiment, store 30 is partitioned into sections 32-44 according to the type(s) of products or merchandise associated with each section 32-44. For example, “produce section” 32 comprises various produce items, while the “clothing section” 40, 42 comprises clothing for women (section 40) and for men (section 42). Regardless of the contents of a particular section, however, the area of each section 32-44 is covered by a set of one or more cameras 20a . . . 20f. According to the present embodiments, the cameras 20 are positioned to track consumers moving through or in that section, and capture images of those consumers in that section. The images are then sent to computer server 16 for analysis and used in generating the behavioral model defining a current behavior of the consumer for that section.

In some cases, the location of a consumer may not be enough with which to accurately determine the consumer's current behavior, thereby making it difficult to accurately predict whether the consumer needs assistance. Therefore, in some embodiments, the present disclosure positions cameras 20e to capture images of various items or objects associated with a given section, such as mirror 46 and/or clothing racks 48 in section 40, as well as images of the consumer. Upon the subsequent receipt and analysis of the digital images, computer server 16 is configured to recognize objects 46, 48 as being located in section 40, and utilize that knowledge as a contextual indicator when determining the current behavior of a consumer.

By way of example only, consider a consumer repeatedly turning around or spinning in section 40. According to the present embodiments, images of mirror 46 and/or racks 48, which are generally at or near the consumer's current location in store 30, may also be captured when capturing images of the consumer. While analyzing the images, computer server 16 could be configured to recognize objects 46, 48 as being positioned in section 40, and determine that the consumer is likely trying on clothes in the section 40. Therefore, in such cases, computer server 16 might determine that the consumer does not require assistance, and that no alert should be sent to a store associate.

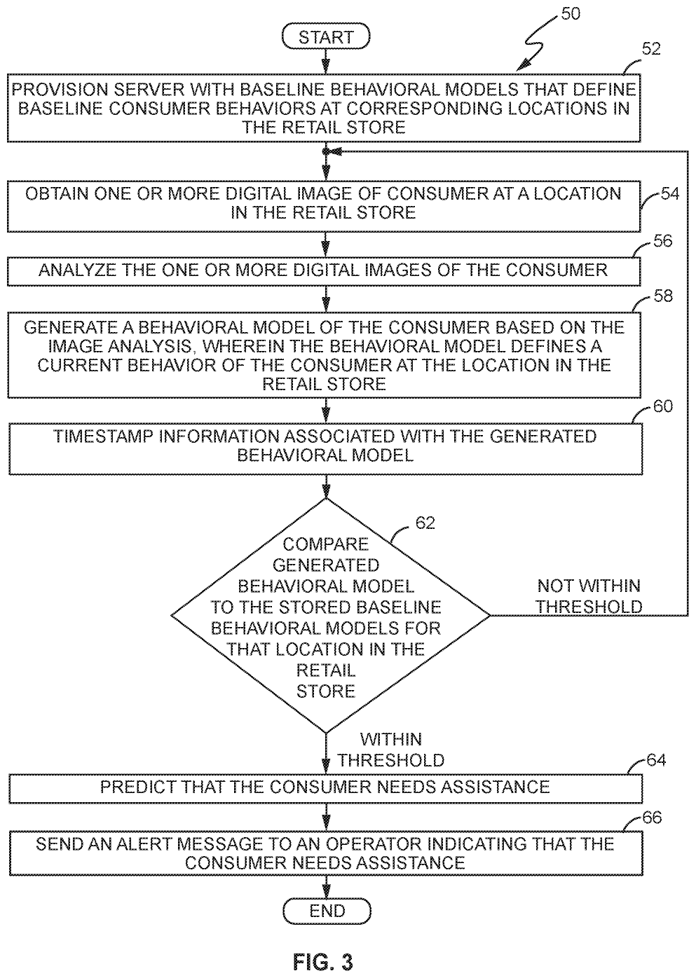

FIG. 3 is a flow diagram illustrating a method 50 for predicting whether a consumer requires assistance based on the behavior of the consumer according to one embodiment of the present disclosure. Method 50 assumes that the store 30 has been partitioned into a plurality of virtual sections, with each section covered by a set of one or more cameras 20.

As seen in FIG. 3, method 50 begins with provisioning computer server 16 with a set of one or more baseline behavioral models (box 52). As previously described, each baseline behavioral model defines a baseline consumer behavior at a given location in store 30. In some embodiments, the provisioning process requires a store operator, for example, to identify which particular gestures and facial expressions indicate a consumer that may require assistance. The following table illustrates a provisioning process according to one embodiment of the present disclosure.

| GESTURE/FACIAL EXPRESSION | 32 | 34 | 36 | 38 | 40 | 42 | 44 |
|---|---|---|---|---|---|---|---|
| Rapid Arm Movements | | X | | X | X | X | |
| Frequent Turning Around | X | X | X | | | | X |
| Wide Eyes | | | X | | | | X |
| Walking Back and Forth in a Repeated | X | X | X | X | | | |
| Pattern | | | | | | | |
| Running | X | X | X | X | X | X | X |
| Standing in One Place for Over 3 | X | X | X | X | X | X | |
| Minutes | | | | | | | |
| Hands on Hips | X | X | X | X | | | |

So provisioned, the operator can set the cameras 20 to monitor the consumers and their movements in each of their corresponding sections 32-44.

Next, method 50 calls for computer server 16 to obtain one or more digital images of a consumer at a location in the store 30 (box 54), and analyze those digital images of the consumer using a digital image analysis technique (box 56). In one embodiment, the digital images are received by computer server 16 directly from cameras 20. However, in other embodiments, computer server 16 obtains the digital images from a mass storage device, such as database 18.

Method 50 then generates a behavioral model of the consumer based on the image analysis (box 58). As previously stated, the behavioral model comprises data and information representing a current behavior of the consumer at the location in store 30 where the images were captured. Such data and information includes, but is not limited to, a facial expression of the consumer and/or a gesture made by the consumer at the location. Method 50 then timestamps the information associated with generating the behavioral model (box 60) and compares the generated behavioral model to the one or more baseline behavioral models stored in database 18 (box 62). In one embodiment, the comparison determines whether the data values in the generated behavioral model are the same or similar to the data values in the baseline behavioral models to within a predetermined threshold. If not, method 50 determines that the consumer does not require assistance and returns to obtain a new set of images. If the values do fall within the predetermined threshold, however, method 50 predicts that the consumer does need assistance (box 64) and sends an alert message to a store associate indicating that the consumer requires assistance (box 66). The alert message may comprise any information needed or desired, but in one embodiment, the alert message is generated by computer server 16 to include at least one image of the consumer that may need assistance, as well as the identity of a location where the consumer is located.

As previously stated, embodiments of the present disclosure utilize machine-learning features to maintain and update the baseline behavioral models, thereby improving the accuracy of the predictions. In particular, store associates, when sent to assist a consumer, provide feedback as to whether the consumer actually did require assistance. The feedback may be provided, for example, using the mobile device of the store associate. This feedback is then analyzed and used to update the baseline behavioral models accordingly.

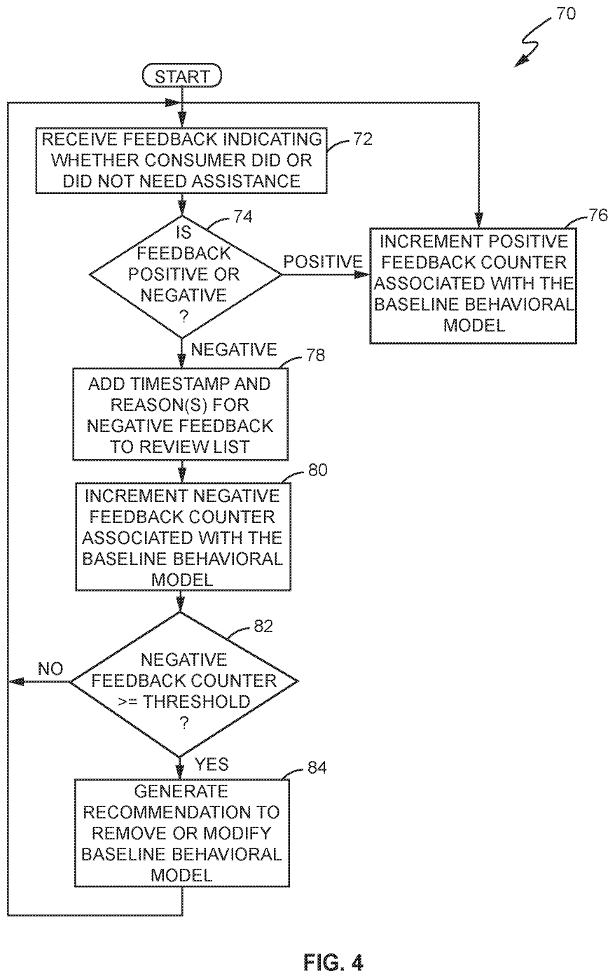

FIG. 4 is a flow diagram illustrating a method 70 for dynamically updating behavioral models that associate a consumer's behavior with whether the consumer needs assistance according to one embodiment of the present disclosure. As seen in FIG. 4, method 70 begins with computer server 16 receiving feedback from the store associate indicating whether the consumer did or did not actually require assistance (box 72). Method 70 then determines whether the feedback data was “positive” or “negative” (box 74). Positive feedback may comprise, for example, a simple indication that the consumer did, in fact, need the help of the store associate. In these cases, method 50 increments a positive feedback counter associated with the baseline behavioral model (box 76) and returns to wait for more feedback (box 72).

Negative feedback may also comprise a simple indication that the consumer did not require assistance, but in at least one embodiment, comprises information (e.g., free form text) provided by the store associate explaining one or more reasons why the consumer did not require assistance. Upon determining that the feedback is negative, method 50 timestamps the feedback and adds the reasons provided by the store associate (box 78), and increments a negative feedback counter associated with the baseline behavioral model (box 80). Method 50 then checks the negative feedback counter to determine whether it is greater than or equal to a predetermined threshold value (box 82).

There are a variety of ways in which the present disclosure can check to determine whether the negative feedback counter is greater than or equal to the predetermined threshold value. However, in one embodiment, the present disclosure performs the check using the following equation.

$$\frac{N}{( N + P )} \geq T$$

where: N=the Negative Feedback Counter;

P =the Positive Feedback Counter; and

T=Predetermined Threshold Value.

If the negative feedback counter is determined to be greater than or equal to the predetermined threshold value, method 50 generates a recommendation to an operator to remove or modify the baseline behavioral model (box 84). Otherwise, method 50 returns to receive the next set of feedback from the store associate (box 72). In this manner, embodiments of the present disclosure learn which baseline behavioral models are not as accurate as they should be, and constantly update those models to be more accurate.

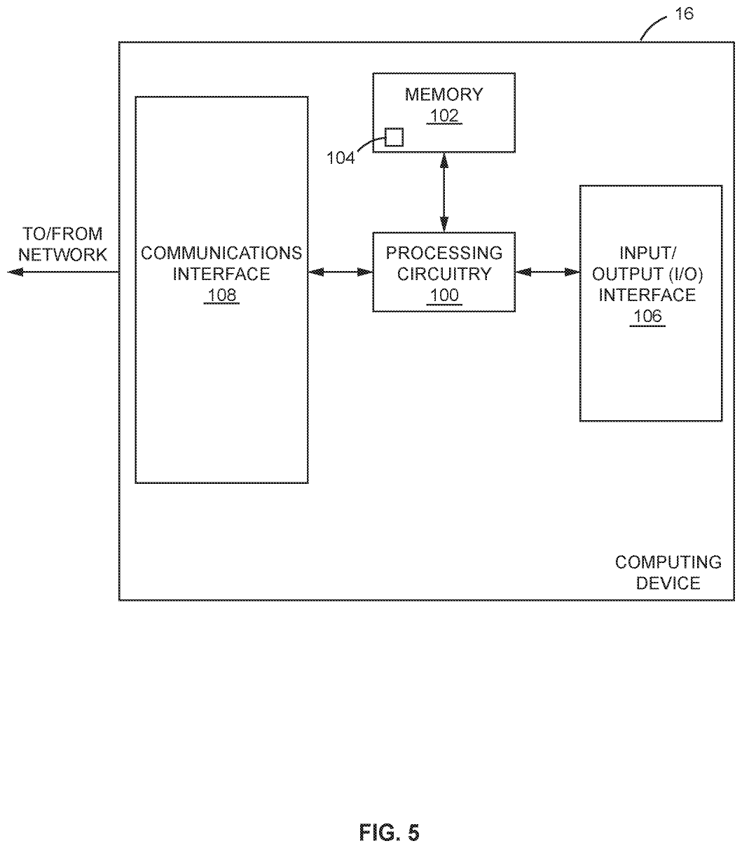

FIG. 5 is a schematic block diagram illustrating the main functional components of computer server 16 according to one embodiment of the present disclosure. As seen in FIG. 5, computer server 16 comprises processing circuitry 100, memory 102, a user input/output (I/O) interface 106, and a communications interface circuit 108.

Processing circuitry 100 comprises one or more microprocessors, hardware circuits, firmware or a combination thereof. In the exemplary embodiments described herein, processing circuitry 100 is configured to obtain one or more digital images of a consumer in a retail store, generate a behavioral model of the consumer indicating the consumer's current behavior based on an image analysis of one or more digital images, predict that the consumer needs assistance from a store associate based on a comparison of the behavioral model to one or more baseline behavioral models stored in a memory, and send an alert message to the store associate indicating to the store associate that the consumer requires assistance. In addition, processing circuitry 100 is configured to receive feedback from the store associate regarding whether the consumer did or did not actually require assistance, and update or modify the baseline behavioral models according to that feedback, as previously described.

Memory 102 comprises a non-transitory computer readable medium that stores program code and data used by the processing circuitry 100 for operation. In this embodiment, the program code and data comprises a control program 104 that, when executed by processing circuitry 100, configures computer server 16 to perform the functions previously described. Memory 102 may include both volatile and non-volatile memory, and may comprise random access memory (RAM), read-only memory (ROM), and electrically erasable programmable ROM (EEPROM) and/or flash memory. Additionally or alternatively, memory 102 may comprise discrete memory devices, or be integrated with one or more microprocessors in the processing circuitry 100.

The user I/O interface 106 comprises, in one or more embodiments, one or more input devices and display devices to enable a user, such as a store associate or operator, for example, to interact with and control computer server 16. Such devices may comprise any type of device for inputting data into a computing device including, but not limited to, keyboards, number pads, push buttons, touchpads, touchscreens, or voice activated inputs. The display devices that comprise user I/O interface 106 may comprise, for example, a liquid crystal display (LCD) or light emitting diode (LED) display. In some embodiments, the display device may comprise a touchscreen display that also functions as a user input device.

The communications interface circuit 108 comprises, in one embodiment, a transceiver circuit and/or interface circuit for communicating with remote devices over a communication network or direct communication link. For example, the communications interface circuit 108 may comprise a WiFi interface, a cellular radio interface, a BLUETOOTH interface, an Ethernet interface, or other similar interface for communicating over a communication network or communication link. Computer server 16 may use the communications interface circuit 108, for example, to communicate with database 18, computer 14, and cameras 20 to obtain information as previously described.

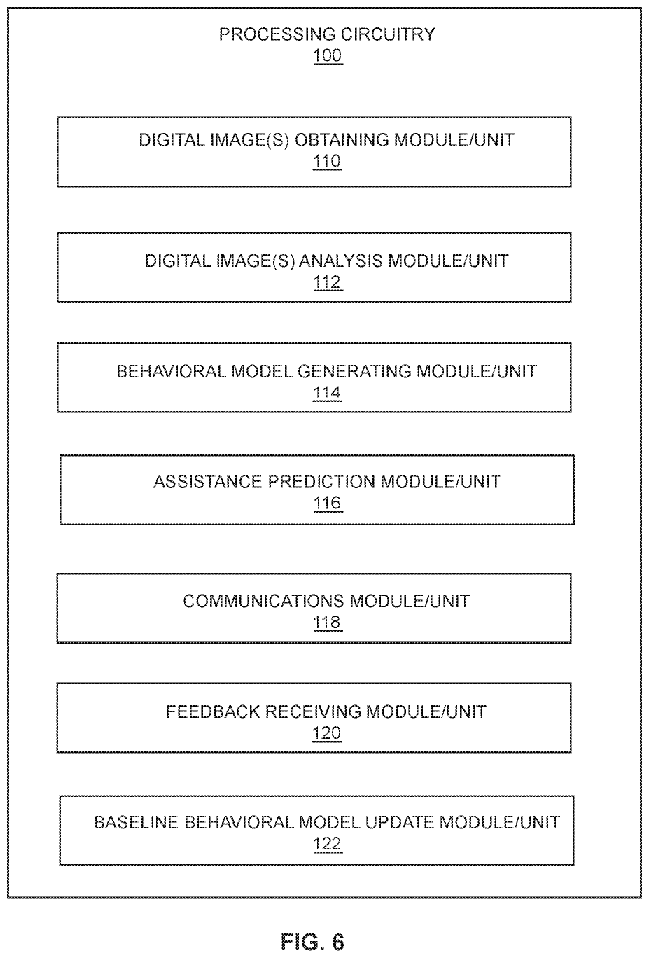

FIG. 6 is a schematic block diagram illustrating a computer program product, such as control program 104. As stated above, control program 104 comprises executable code that, when executed by processing circuitry 100, causes computer server 16 to predict whether a consumer requires assistance based on the behavior of the consumer according to one embodiment of the present disclosure. As seen in FIG. 6, the control program 104 may be embodied in a non-transitory, computer-readable medium, such as the memory 102 of computer server 16, or alternatively, in a removable memory device, such as a thumb drive or disc. Control program 104 in this embodiment comprises a digital image obtaining module/unit 110, a digital image analysis module/unit 112, a behavioral model generating module/unit 114, an assistance prediction module/unit 116, a communications module/unit 118, a feedback receiving module/unit 120, and a baseline behavioral model update module/unit 122.

The digital image obtaining module/unit 110 comprises program code that is executed by processing circuitry 100 to obtain the one or more digital images of the consumer. The digital image analysis module/unit 112 comprises program code executed by processing circuitry 100 to perform a digital image analysis on the captured images. The behavioral model generating module/unit 114 comprises computer program code that configures processing circuitry 100 to generate the behavioral models defining the current behavior of the consumer. The assistance prediction module/unit 116 comprises computer program code that when executed by processing circuitry 100, causes processing circuitry 100 to predict whether a consumer requires assistance based on the results of the image analysis. The communications module/unit 118 comprises computer program code that configures processing circuitry 100 to communicate with one or more remote devices, such as database 18, computer 14, and cameras 20, via network 12. The feedback receiving module/unit 120 comprises computer program code that configures processing circuitry 100 to receive feedback from store associates, and a baseline behavioral model update module/unit 122 configured to modify and/or update the baseline behavioral models, as previously described. Additionally, in at least one embodiment, the baseline behavioral model update module/unit 122 also configures processing circuitry 100 to obtain the one or more baseline behavioral models used in the present embodiments.

The present embodiments may, of course, be carried out in ways other than those specifically set forth herein without departing from essential characteristics of the disclosure. Therefore, the present embodiments are to be considered in all respects as illustrative and not restrictive, and all changes coming within the meaning and equivalency range of the appended claims are intended to be embraced therein.

What is claimed is:

1. A method for predicting whether a consumer in a retail store needs assistance, the method comprising:
generating a behavioral model of a consumer in a retail store based on an image analysis of one or more digital images of the consumer at a location in the retail store, wherein the behavioral model defines a current behavior of the consumer at the location;
predicting that the consumer needs assistance based on a comparison of the behavioral model to one or more baseline behavioral models stored in a memory, wherein each baseline behavioral model defines a baseline consumer behavior at corresponding locations in the retail store; and
sending an alert message to an operator associated with the retail store indicating that the consumer needs assistance, wherein the alert message identifies the consumer and the location of the consumer in the retail store.

2. The method of claim 1 wherein the behavioral model is generated to comprise data indicating a body language profile of the consumer at the location of the consumer within the retail store.

3. The method of claim 2 wherein the data indicating the body language profile of the consumer indicates one or both of:
a gesture made by the consumer; and
a facial expression made by the consumer.

4. The method of claim 2 wherein each baseline behavioral model comprises a baseline body language profile for consumers at the location in the retail store with each baseline body language profile comprising data indicating one or both of:
a baseline gesture; and
a baseline facial expression.

5. The method of claim 4 further comprising:
receiving feedback indicating whether the consumer needed the assistance; and
updating the one or more baseline behavioral models based on the feedback.

6. The method of claim 5 wherein updating the one or more baseline behavioral models based on the feedback comprises one of:
updating a negative feedback counter associated with the baseline behavioral model that was compared to the generated behavioral model if the feedback is negative feedback; and
updating a positive feedback counter associated with the baseline behavioral model that was compared to the generated behavioral model if the feedback is positive feedback.

7. The method of claim 1 wherein the retail store is virtually partitioned into a plurality of sections, and wherein each section is associated with one or more baseline behavioral models, each defining a different baseline consumer behavior in that section.

8. The method of claim 1 wherein generating a behavioral model of the consumer further comprises:
identifying one or more contextual indicators in the one or more digital images based on the image analysis, wherein each contextual indicator identifies an object at the location of the consumer in the retail store; and
generating the behavioral model to comprise data identifying the one or more contextual indicators.

9. The method of claim 1 further comprising timestamping the behavioral model to indicate when the current behavior of the consumer was detected.

10. The method of claim 1 further comprising obtaining the one or more digital images of the consumer at the location in the retail store.

11. A computing device configured to predict whether a consumer in a retail store needs assistance, the computing device comprising:
a communications interface circuit configured to communicatively connect the computing device to a communications network; and
processing circuitry configured to:
generate a behavioral model of a consumer in a retail store based on an image analysis of one or more digital images of the consumer at a location in the retail store, wherein the behavioral model defines a current behavior of the consumer at the location;
predict that the consumer needs assistance based on a comparison of the behavioral model to one or more baseline behavioral models stored in a memory, wherein each baseline behavioral model defines a baseline consumer behavior at corresponding locations in the retail store; and
send an alert message to an operator associated with the retail store indicating that the consumer needs assistance, wherein the alert message identifies the consumer and the location of the consumer in the retail store.

12. The computing device of claim 11 wherein the processing circuitry is configured to generate the behavioral model to comprise data indicating a body language profile of the consumer at the location of the consumer within the retail store.

13. The computing device of claim 12 wherein the data indicating the body language profile of the consumer indicates one or both of:
a gesture made by the consumer; and
a facial expression made by the consumer.

14. The computing device of claim 11 wherein the retail store is virtually partitioned into a plurality of sections, and wherein each section is associated with one or more baseline behavioral models, each defining a different baseline consumer behavior in that section.

15. The computing device of claim 11 wherein to generate a behavioral model of the consumer, the processing circuit is further configured to:
identify one or more contextual indicators in the one or more digital images based on the image analysis, wherein each contextual indicator identifies an object at the location of the consumer in the retail store; and
generate the behavioral model to comprise data identifying the one or more contextual indicators.

16. The computing device of claim 11 wherein the processing circuitry is further configured to timestamp the behavioral model to indicate when the current behavior of the consumer was detected.

17. The computing device of claim 11 wherein each baseline behavioral model comprises a baseline body language profile for consumers at the location in the retail store with each baseline body language profile comprising data indicating one or both of:
a baseline gesture; and
a baseline facial expression.

18. The computing device of claim 17 wherein the processing circuitry is further configured to:
receive feedback indicating whether the consumer needed the assistance; and
update the one or more baseline behavioral models based on the feedback.

19. The computing device of claim 18 wherein to update the one or more baseline behavioral models based on the feedback, the processing circuitry is further configured to:
update a negative feedback counter associated with the baseline behavioral model that was compared to the generated behavioral model if the feedback is negative feedback; and
update a positive feedback counter associated with the baseline behavioral model that was compared to the generated behavioral model if the feedback is positive feedback.

20. A non-transitory computer readable medium comprising executable program code that, when executed by a processing circuit in a computing device, causes the computing device to:
generate a behavioral model of a consumer in a retail store based on an image analysis of one or more digital images of the consumer at a location in the retail store, wherein the behavioral model defines a current behavior of the consumer at the location;
predict that the consumer needs assistance based on a comparison of the behavioral model to one or more baseline behavioral models stored in a memory, wherein each baseline behavioral model defines a baseline consumer behavior at corresponding locations in the retail store; and
send an alert message to an operator associated with the retail store indicating that the consumer needs assistance, wherein the alert message identifies the consumer and the location of the consumer in the retail store.
